(19) United States
(12) Patent Application Publication
(10) Pub. No.: US 2012/0098429 A1
(43) Pub. Date: Apr. 26, 2012

(54) LED LAMP WITH HEAT DISSIPATION

(76) Inventor: Ching-Long Liang, Rende Shiang (TW)

(21) Appl. No.: 12/909,871

(22) Filed: Oct. 22, 2010

(51) Int. Cl. H01K 1/62

(52) U.S. Cl. 315/70

(57) ABSTRACT

A LED lamp with heat dissipation includes a transfer adapter, a heatsink, a heat-conducting plate, a circuit board and a lampshade. The heatsink, the heat-conducting plate and the circuit board are all made of aluminum. A through hole inside the heatsink is provided therein with plural air channels communicating with the outer wall at one end of the heat-dissipating base and formed with air slots. The heatsink has its outer wall disposed with plural heat-dissipating blades having a heat-dissipating recess formed between there and has one end formed with a flange. The heat-conducting plate has one end provided with a recessed groove to be engaged with the flange of the heatsink and another end provided with an accommodating chamber with plural heat-dissipating holes respectively aligned to the air channels of the heatsink. The circuit board is provided thereon with an LED chip.

### BACKGROUND OF THE INVENTION

1. Field of the Invention

This invention relates to an LED lamp with heat dissipation, particularly to one provided with an aluminum lamp bulb holder and an aluminum circuit board, able to lower power comsumption, dissipate heat quickly, prevent burning from replacement of a lamp bulb and provide long operating duration.

2. Description of the Prior Art

A conventional lamp bulb 1 using tungsten filament 10 as a luminous source, as shown in FIG. 1, is provided with a bulb holder 11 having its outer side formed with male threads 110 and its upper portion mounted with a spherical lampshade 12 receiving the tungsten filament 10 in the interior. The tungsten filament 10 has its lower end connected with electric power lines 13 that are connected to the interior of the lamp bulb holder 11 to be electrically connected for enabling the tungsten filament 10 to be heated and lighted. However, the conventional tungsten lamp bulb is easy to produce extremely high temperature while lighting up, and the tungsten filament 10 is likely to be burned, thus shortening operating duration of the tungsten lamp bulb. In addition, when replacing the lamp bulb 1, a person's hand is easily burned by high temperature of the lampshade 12.

### SUMMARY OF THE INVENTION

The objective of this invention is to offer an LED lamp with heat dissipation, low power consumption, able to prevent burning from replacement of lamp bulb and able to provide longer operating duration.

The LED lamp with heat dissipation in the present invention includes a transfer adapter, a heatsink, a heat-conducting plate, a circuit board and a lampshade combined together. The transfer adapter has its outer wall provided with male threads and one end formed with a flange provided with male threads. The heatsink made of aluminum and combined with the adapter is formed in the interior with a through hole having its wall provided with a plurality of air channels respectively communicating with the outer wall at one end of the heatsink and formed with an air slot. The heatsink has another end provided with a flange and its outer wall disposed with a plurality of heat-dissipating blades, a heat-dissipating recess formed between every two heat-dissipating blades, and the through hole of the heatsink has one end provided with female threads to be screwed with the transfer adapter. The heat-conducting plate made of aluminum and engaged on the heatsink has one end disposed with a recessed groove to be engaged with the flange of the heatsink and another end formed with an accommodating chamber having its inner wall surface provided with plural insert holes and threaded holes, and also bored with plural heat-dissipating holes that are respectively aligned to the air channels of the heatsink and an insert slot. A plurality of screws are respectively inserted through the insert holes and then firmly screwed with the heatsink. The circuit board made of aluminum and received in the accommodating chamber of the heat-conducting plate is provided thereon with an LED chip and bored with plural insert holes respectively inserted therein with a screw to be screwed on the heat-conducting plate. Further, the circuit board is fixed thereon with electric power lines to be inserted through the insert slot of the heat-conducting plate and connected with a transformer, which is additionally provided with electric power lines connected to the interior of the transfer adapter. The lampshade being translucent is assembled on the heat-conducting plate.

### BRIEF DESCRIPTION OF DRAWINGS

This invention will be better understood by referring to the accompanying drawings, wherein:

FIG. 1 is a schematic view of a conventional lamp bulb;

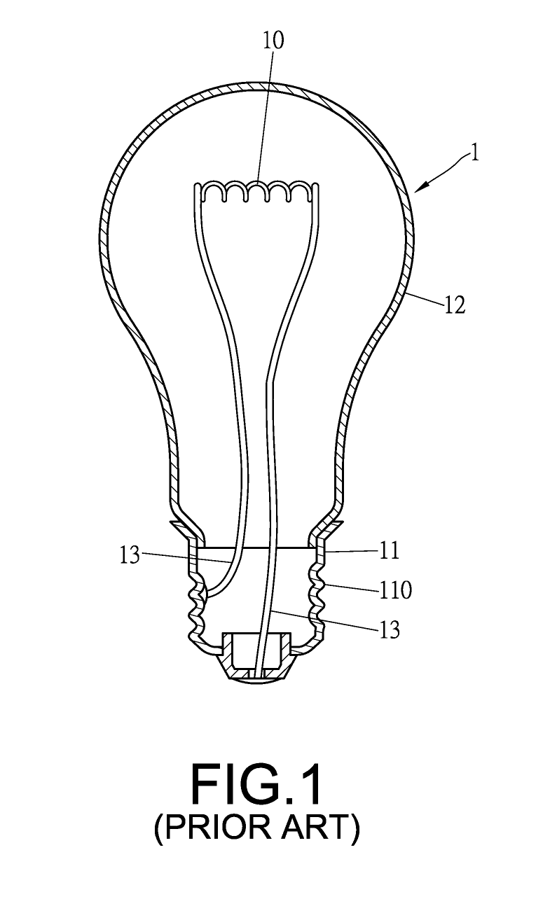

FIG. 2 is an exploded perspective view of an LED lamp with heat dissipation in the present invention;

FIG. 3 is schematic views respectively showing the thickness of a heat-conducting plate and the distance of one heat-dissipating blade plus one heat-dissipating recess of a heatsink in the present invention;

FIG. 4 is a perspective view of the LED lamp with heat dissipation in the present invention;

FIG. 5 is a cross-sectional view of the LED lamp with heat dissipation in the present invention; and

FIG. 6 is another cross-sectional view of the LED lamp with heat dissipation, viewed from another angle in the present invention.

### DETAILED DESCRIPTION OF THE PREFERRED EMBODIMENT

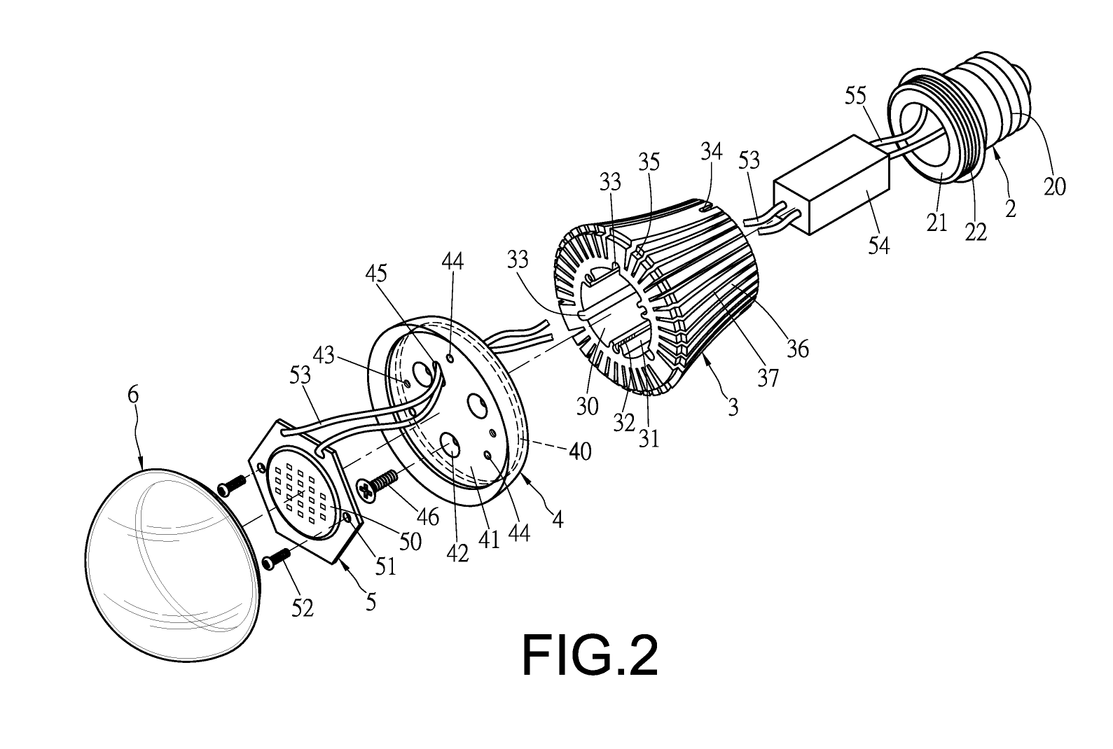

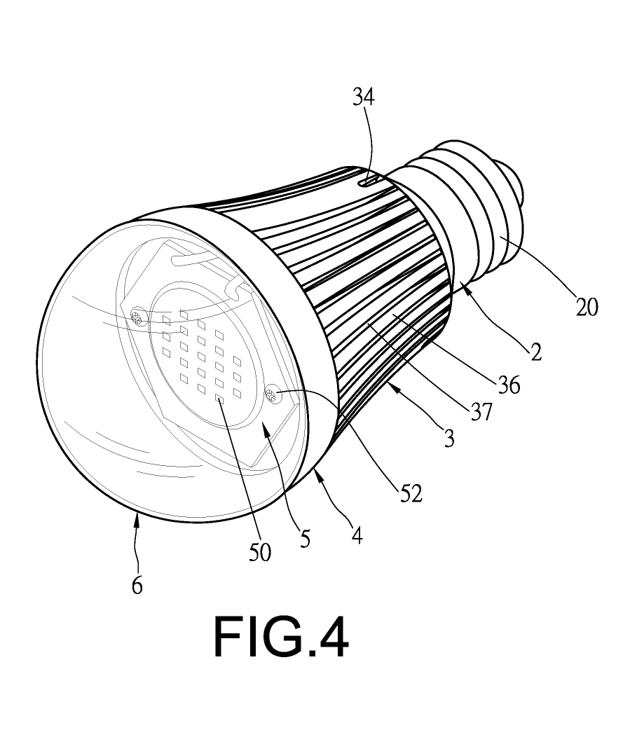

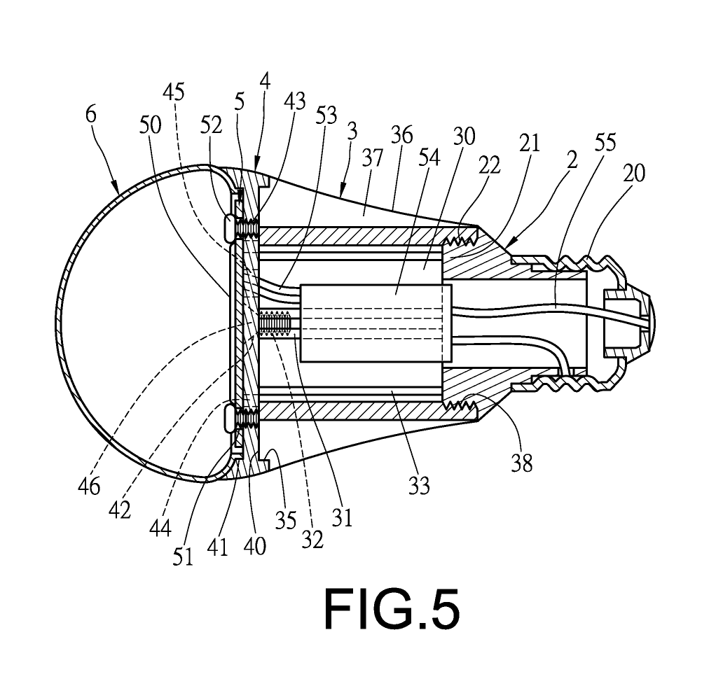

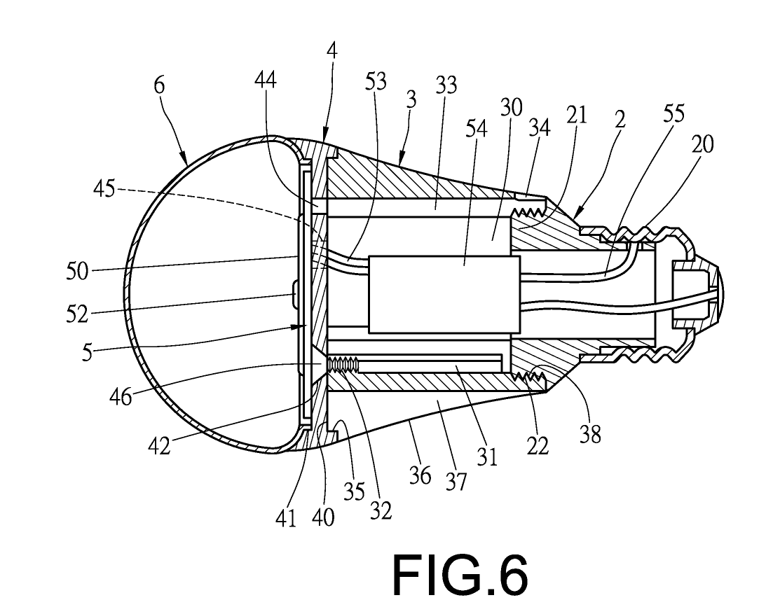

A preferred embodiment of an LED lamp with heat dissipation in the present invention, as shown in FIGS. 2 to 6, includes a transfer adapter 2, a heatsink 3, a heat-conducting plate 4, a circuit board 5 and a lampshade 6 as main components combined together.

The transfer adapter 2 has its outer wall formed with male threads 20 and one end provided with a flange 21 with male threads 22.

The heatsink 3 made of aluminum and combined with the transfer adapter 2 is disposed in the interior with a through hole 30 fixed inside with a plurality of projections 31 respectively provided with a female threaded section 32. The through hole 30 has its wall provided with at least three air channels 33 spaced apart equidistantly, and respectively communicating with the outer wall at one end of the heatsink 3 and formed with an air slot 34. The heatsink 3 has another end formed with a flange 35 and its outer wall disposed with lots of heat-dissipating blades 36 having a heat-dissipating recess 37 formed between every two heat-dissipating blades 36. Further, the through hole 30 of the heatsink 3 has one end provided with female threads 38.

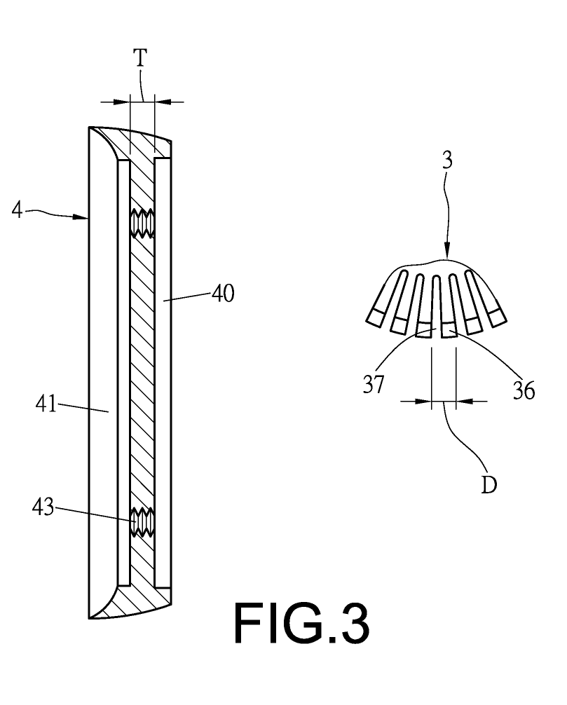

The heat-conducting plate 4 made of aluminum is mounted on the heatsink 3, having one end formed with an annular recessed groove 40 and another end provided with an accommodating chamber 41 having its inner wall surface bored with plural insert holes 42, threaded holes 43 and heat-dissipating holes 44 and an insert slot 45. The thickness (T) between the bottom of the accommodating Chamber 41 and the bottom of the recessed groove 40 at another end of the heat-conducting plate 4 is equal to the distance (D) of one heat-dissipating blade 36 plus one heat-dissipating recess 37, as shown in FIG. 3. A plurality of screws 46 are respectively inserted through the insert holes 42.

The circuit board 5 made of aluminum is received in the accommodating chamber 41 of the heat-conducting plate 4, provided thereon with an LED chip 50 and bored with a plurality of insert holes 51 respectively inserted therein with a screw 52. The circuit board 5 is further fixed thereon with electric power lines 53 connected to a transformer 54, which is additionally provided with electric power lines 55 connected to the interior of the adapter 2.

The lampshade 6 being translucent is assembled on the heat-conducting plate 4.

In assembling, referring to FIGS. 2 to 6, firstly, have the flange 21 of the adapter 2 threadably assembled at one end of the heatsink 3, letting the male threads 22 on the flange 21 engaging with the female threads 38 of the heatsink 3 to position the transformer 54 in the through hole 30 of the heatsink 3. Next, assemble the heat-conducting plate 4 on the heatsink 3, letting the flange 35 of the heatsink 3 positioned in the recessed groove 40 at one side of the heat-conducting plate 4 and having the insert holes 42 of the heat-conducting plate 4 respectively aligned to the female threaded section 32 in the projections 31 of the heatsink 3. Then, the screws 46 are respectively inserted through the insert holes 42 of the heat-conducting plate 4 and firmly screwed with the female threaded sections 32 of the heatsink 3 to firmly fix the heat-conducting plate 4 on the heatsink 3, letting the heat-dissipating holes 44 respectively aligned to the air channels 33 of the heatsink 3. Subsequently, the circuit board 5 is placed in the accommodating chamber 41 of the heat-conducting plate 4, letting the insert holes 51 of the circuit board 5 respectively aligned to the threaded holes 43 of the heat-conducting plate 4, and then the screws 52 are respectively inserted through the insert holes 51 of the circuit board 5 and fixedly screwed in the threaded holes 43 of the heat-conducting plate 4 to steadily assembled the circuit board 5 on the heat-conducting plate 4. Lastly, the electric power lines 53 of the circuit board 5 are inserted through the insert slot 45 of the heat-conducting plate 4, and the lampshade 6 is fixed on the accommodating chamber 41 of the heat-conducting plate 4, thus finishing assembly.

In using, referring to FIGS. 3, 5 and 6, after the LED is assembled on a lamp holder and electrically connected, the transformer 54 will convert A. C. into D. C. to supply the LED chip 50 on the circuit board 5 with D. C. for emitting bright light, and simultaneously the bright light will be projected out for lighting through the translucent lampshade 6. After the LED chip 50 is electrically connected, high temperature produced by the LED chip 50 will be quickly transmitted to the aluminum heat-conducting plate 4 via the aluminum circuit board 5, able to absorb heat quickly. Then, the high temperature will be quickly transmitted to the aluminum heat-dissipating base 3 via the aluminum heat-conducting plate 4 to be quickly lowered down by means of the heat-dissipating blades 36 and the heat-dissipating recesses 37 on the outer wall of the heatsink 3. In addition, high temperature produced by the circuit board 5 can be directly exhausted out through the heat-dissipating holes 44 of the heat-conducting plate 4 and also be guided by the air channels 33 of the heatsink 3 to be exhausted out through the air slot 34, able to dissipate heat quickly and lower temperature. Moreover, the thickness (T) of the heat-conducting plate 4 is designed to be equal to the distance (D) of one heat-dissipating blade 36 plus one heat-dissipating recess 37 on the heatsink 3, thus attaining excellent effect of heat absorption and dissipation, able to quickly reduce tempure of the lamp bulb, preventing burning from replacement of the bulb.

Furthermore, the LED Lamp bulb can have long operating duration and won't flicker while lighting up.

As can be understood from the above description, this invention has the following advantage:

1. In present invention, a LED chip is used to lower power comsumption

2. The circuit board, the heat-conducting plate and the heatsink of this invention are all made of aluminum, able to absorb and dissipate heat quickly.

3. By so designing, high temperature of a lamp bulb can be lowered quickly, thus preventing a person's fingers burned while replacing of the lamp bulb.

4. In the present invention, the LED Lamp can have long operating duration.

5. The LED lamp of this invention will not flicker while lighting up. While the preferred embodiment of the invention has been described above, it will be recognized and understood that various modifications may be made therein and the appended claims are intended to cover all such modifications that may fall within the spirit and scope of the invention.

What is claimed is:

1. A LED lamp with heat dissipation comprising:
A transfer adapter having an outer wall provided with male threads, said transfer adapter having one end formed with a flange, said flange provided thereon with male threads;
a heatsink mounted on said transfer adapter, said heatsink made of aluminum, said heatsink disposed in an interior with a through hole having an inner wall provided with a plurality of air channels, said air channels communicating with an outer wall at one end of said heatsink and respectively formed with an air slot, said heatsink having another end formed with a flange and an outer wall provided with plural heat-dissipating blades, a heat-dissipating recess formed between every two of said heat-dissipating blades, said through hole of said heatsink having one end disposed with female threads to be screwed with said transfer adapter;
a heat-conducting plate engaged with said heatsink, said heat-conducting plate made of aluminum, said heat-conducting plate having one end provided with a recessed groove to be engaged with said flange of said heatsink, said heat-conducting plate having another end formed with an accommodating chamber, said accommodating chamber having an inner wall surface bored with plural insert holes, threaded holes and heat-dissipating holes, said heat-dissipating holes respectively aligned to said air channels of said heatsink, said accommodating chamber having an inner wall bored with an inert slot, a plurality of screws respectively inserted through said insert holes and firmly screwed with said heatsink;
a circuit board received in said accommodating chamber of said heat-conducting plate, said circuit board made of aluminum, said circuit board provided thereon with an LED chip, said circuit board bored with plural insert holes respectively having a screw inserted therein, said screw threadably fixed on said heat-conducting plate, said circuit board provided with electric power lines to be inserted through said insert slot of said heat-conducting plate and connected with a transformer, said transformer additionally provided with electric power lines connected to an interior of said adapter; and
a lampshade assembled on said heat-conducting plate, said lampshade being translucent.

2. The LED lamp with heat dissipation as claimed in claim 1, wherein a thickness between a bottom of said accommodating chamber of said heat-conducting plate and a bottom of said recessed groove at another end of said heat-conducting plate is equal to a distance of one of said heat-dissipating blade plus one of said heat-dissipating recess of said heatsink.

3. The LED lamp with heat dissipation as claimed in claim 1, wherein said through hole of said heatsink is provided inside with a plurality of projections respectively formed in the interior with a female threaded section for a screw to be screwed therein.

4. The LED with heat dissipation as claimed in claim 1, wherein there are at least three of said air channels provided in the interior of said heatsink and there are at least three of said heat-dissipating holes bored on said heat-conducting plate.
